(19) United States
(12) Patent Application Publication
(10) Pub. No.: US 2004/0266348 A1
(43) Pub. Date: Dec. 30, 2004

(54) Method and apparatus for finding and sharing device capabilities

(76) Inventors: Nikhil Deshpande, Beaverton, OR (US); Robert Knauerhase, Portland, OR (US); Du Nguyen, Tigard, OR (US); Uttam Sengupta, Portland, OR (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/608,110

(22) Filed: Jun. 30, 2003

(51) Int. Cl. H04B 1/00

(52) U.S. Cl. 455/41.2; 370/338

(57) ABSTRACT

An apparatus and method to receive from a requesting device a request to share a capability of a sharing device located in the vicinity of the requesting device and to compare presence information of the requesting device and the sharing devices to find a match.

### BACKGROUND OF THE INVENTION

Many mobile-device users may carry multiple mobile devices, such as a laptop or a notebook computer, a handheld computer, a cellular telephone, a pager, a personal digital assistant (PDA), and the like. Those devices may have specific roles. These roles may be primarily determined by device-specific capabilities. For example, a user may carry a personal digital assistant that enables fast access to personal information, such as a telephone list and calendar information. The user may also carry a laptop computer, which has better processing and output display capabilities. In some cases, it may be desirable for the user to be able to carry fewer devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is an illustration of an exemplary hybrid communication system according to embodiments of the present invention;

FIG. 2 is a block diagram of a server according to exemplary embodiments of the present invention;

FIG. 3 is a block diagram of a requesting device according to an exemplary embodiment of the invention; and

FIG. 4 is an flowchart of a method of sharing device capabilities according to some exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operation herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROM's), compact disc read-only memories (CD-ROM's), digital video disc read only memory (DVD-ROM), random access memories (RAM's), electrically programmable read-only memories (EPROM's), electrically erasable and programmable read only memories (EEPROM's), FLASH memory, magnetic or optical cards, or any other type of media suitable for storing electronic instructions and capable of being coupled to a computer system bus.

It should be appreciated that according to some embodiments of the present invention, the method described below, may be implemented in machine-executable instructions. These instructions may be used to cause a general-purpose or special-purpose processor that is programmed with the instructions to perform the operations described. Alternatively, the operations may be performed by specific hardware that may contain hardwired logic for performing the operations, or by any combination of programmed computer components and custom hardware components.

Although the scope of the present invention is not limited in this respect, embodiments of the present invention may include a hybrid communication system. The hybrid communication system may include an at least one wireless communication system such as, for example, wireless local area network (WLAN), wireless ad-hoc network, cellular communication system, two way communication system, optical communication system and the like. In addition, the hybrid communication system may include local area network (LAN), wide area network (WAN), the Internet, telephony network, or the like.

Types of WLAN communication systems intended to be within the scope of the present invention include, although are not limited to, “IEEE standard 802.11, IEEE-Std 802.11, 1999 Edition (ISO/IEC 8802-11: 1999)”, and more particularly in “IEEE-Std 802.11b-1999, IEEE-Std 802.11a, IEEE-Std 802.11g, IEEE-Std 802.11j. Types of WLAN communication systems intended to be within the scope of the present invention may further include IEEE standard 802.15, IEEE-Std 802.15 Wireless Personal Network (WPAN), IEEE standard 802.16, IEEE-Std 802.16 WirelessMAN™ Standard for Wireless Metropolitan Area Networks (WMAN), IEEE standard 802.20, IEEE-Std 802.20 Mobile Broadband Wireless Access (MBWA) Mobile Broadband Wireless Access (MBWA), or the like.

Types of cellular radiotelephone systems intended to be within the scope of the present invention include, although are not limited to, Code Division Multiple Access (CDMA) and WCDMA cellular radiotelephone portable devices for transmitting and receiving spread spectrum signals, Global System for Mobile communication (GSM) cellular radiotelephone, Enhanced Data for GSM Evolution (EDGE), Time Division Multiple Access (TDMA), Extended-TDMA (E-TDMA), General Packet Radio Service (GPRS), Extended GPRS, High-Speed Downlink Packet Access (HSDPA), CDMA2000 which may include One Times Radio Transmission Technology (1×RTT) Evolution Data Only (EvDO/EvDV) and the like.

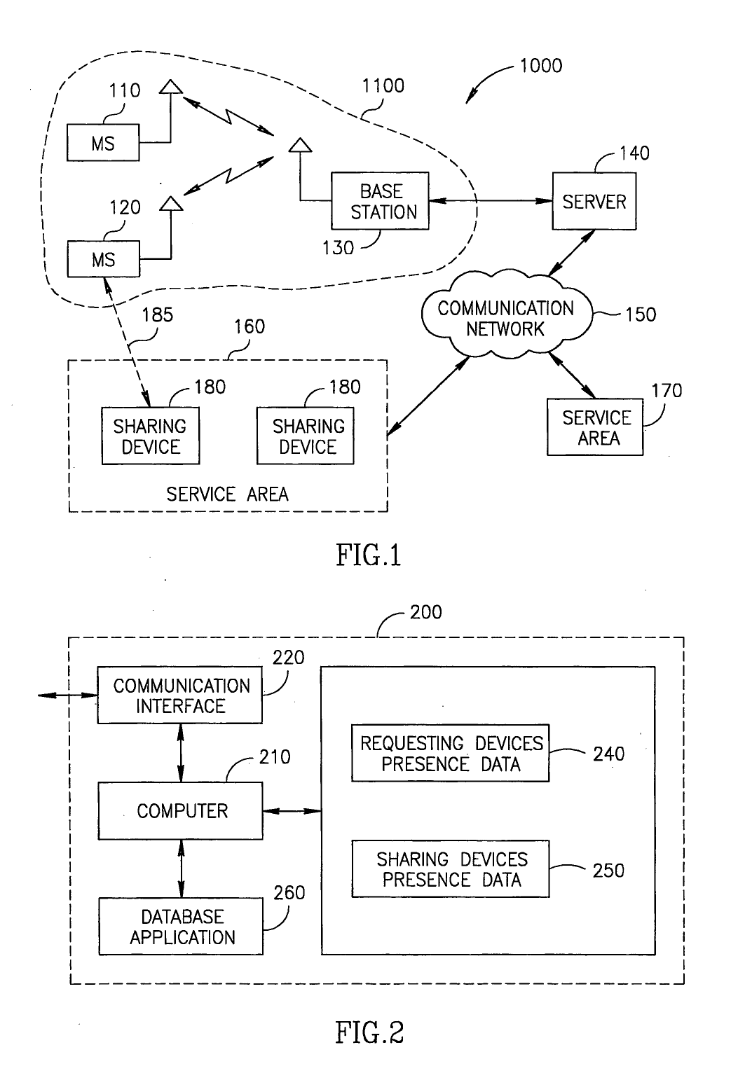

Turning first to FIG. 1, an illustration of an exemplary hybrid communication system 1000 according to embodiments of the present invention is shown. Although the scope of the present invention is not limited in this respect, hybrid communication system may include a wireless communication system 1100, a server 140, a communication network 150 which may be a wired communication network or wireless communication network, and service areas 160, 170.

Although the scope of the present invention is not limited in this respect, wireless communication system 1100 may include mobile stations 110, 120 and a base station 130. In embodiments of the present invention, mobile stations 110, 120 may be, for example, cellular telephones, laptop computers, smart telephones, personal digital assistants (PDAs), data collecting terminals, game consoles, two way communication device, or the like. Throughout the specification mobile station such as, for example, mobile station 120 that may request a service, will be termed as a requesting device.

Although the scope of the present invention is not limited in this request, server 140 may be connected to wireless communication system 1100 and to communication network 150, if desired. In some embodiments of the present invention server 140 may be an information server and may be able to provide a capability-sharing service. Server 140 may be able to process the request for service from mobile station 110 or 120 and to provide the requesting device with directions to a service area, for example service area 160, which may be in the vicinity of the requesting device (e.g., mobile station 120).

Although the scope of the present invention is not limited in this respect, service areas 160, 170 may be located, for example, in airports, seaports, spaceports, shopping centers, shopping area, hospitals, libraries, hotels, schools, universities, industrial campuses and the like. For example, service areas may include one or more sharing devices 180, which may share their capabilities with the requesting device, e.g., mobile station 120.

Although the scope of the present invention is not limited in this respect, one or more sharing devices 180 may share capabilities such as, for example, hardware capabilities and/or software capabilities. For example, the hardware capabilities may include, but are not limited to, wireless and non wireless input devices such as, for example, keyboard, mouse, camera, microphone, scanners and the like. The hardware capabilities may further include wireless and non-wireless output devices such as, for example, display devices, imaging devices, audio devices, printers, facsimiles, and the like. Furthermore, the hardware capabilities of sharing device 180 may include storage capabilities such as CD-ROM, DVD-ROM, and the like. In addition, the software capabilities of sharing device 180 may include sharing software applications, drivers and the like.

Although the scope of the present invention is not limited in this respect, the requesting device (e.g., mobile station 120) may establish a wired connection and/or wireless connection with one or more sharing devices 180. For example, a wired connection may be achieved through a universal serial bus (USB) port, a parallel port, a serial port and the like. The wireless connection may be achieved using, for example, one or more of the wireless standards or protocols, such as, for example, Bluetooth, the IEEE standard IEEE-Std 802.11a, the IEEE standard IEEE-Std 802.11b, 1999 edition, the IEEE standard IEEE-Std 802.11g, HomeRF and InfraRed Data Association (IrDA) standard, if desired.

Turning to FIG. 2, a block diagram of a server 200 according to exemplary embodiments of the present invention is shown. Although the scope of the present invention is not limited in this respect, server 200 may include a computer 210, a communication interface 220 and a storage unit 230. Storage unit 230 may have stored therein requesting devices presence data 240 and sharing devices presence data 250. Throughout the specification and the claims the terms “presence data” and “presence information” refer to any information related to the sharing devices or the requesting devices and may include data related to requested capabilities and available sharing capabilities.

In some embodiments of the invention communication interface 220 may be a network interface card (NIC), or other interface card to enable server 200 to be connected to network and/or to a base station and/or AP of wireless communication system. Additionally or alternatively, in other embodiments of the present invention communication interface may be a wireless NIC, AP, RF transceiver, which may operate with a cellular communication system, a bridge, a router or the like.

Although the scope of the present invention is not limited in this respect, communication interface 220 may receive and transmit input from/to sharing devices 180 and data from/to requesting devices (e.g., mobile stations 110, 120). Computer 210 may store the data in storage unit 230 and may deliver output data to sharing devices 180 and the requesting devices, if desired. Although the scope of the present invention is not limited in this respect, computer 210 may be a reduced instruction set computer (RISC), a complex instruction set computer (CISC), and the like. Additionally or alternatively, computer 210 may be a computer system, which may include, among other components, a memory or memories. In embodiments of the invention, computer 210 may operate a database application 260, for example, a data base application that support structure query language (SQL) or a database query language, if desire.

Although the scope of the present invention is not limited in this respect, sharing-devices presence data 250 may include records of sharing devices, e.g., sharing devices 180. For example, a record of a sharing device may include identification such as, for example, an identification (ID) number and/or an IP address and the like. The exemplary record may further include respective capabilities of the sharing device, a location of the sharing, current availability (status) of the sharing device, and/or a type of connection, or any other desirable information. An exemplary record of a sharing-device may be the following:

Description—Keyboard, IP address —125.124.125,

Capability—Good input capability, Location—JFK

Airport Gate A15; Status—In use; Type of connection —Infra

Red.

Although the scope of the present invention is not limited in this respect, requesting-devices presence data 240 may include records of mobile stations, e.g. stations 110, 120 currently registered to server 200. A record of a requesting device may include identification such as, for example, an ID number and/or an IP address and the like. The exemplary record may further include a type of the requesting device, an indication of the sharing device to which the requesting device is currently connected or reserved (status), a type of communication interface for receiving the service of a respective request, a location at the time of sending the request, service account details, and the like. The requesting device may send a request, which may include one or more of the above-describe details and the specific request for sharing capabilities. An exemplary record of a requesting-device may be the following:

Laptop computer—Request: a display—current

location: JFK Airport Gate B6— Connected to NONE;

Connection type: standard display cable; Account information such as, for example, user ID, pass code, and the like

Although the scope of the present invention is not limited in this respect, storage unit 230 may include multiple storage units and multiple types of storage units may be present. In alternate embodiments of the invention storage unit 230 may be coupled to server 200 via communication network 150, or other network if desired. Server 200 may be a presence server that may provide information of IP address, physical location, status of devices such as, for example, if they are connected or reserved, and the like. In addition server 200 may be used by service providers to provide sharing capabilities service, if desired.

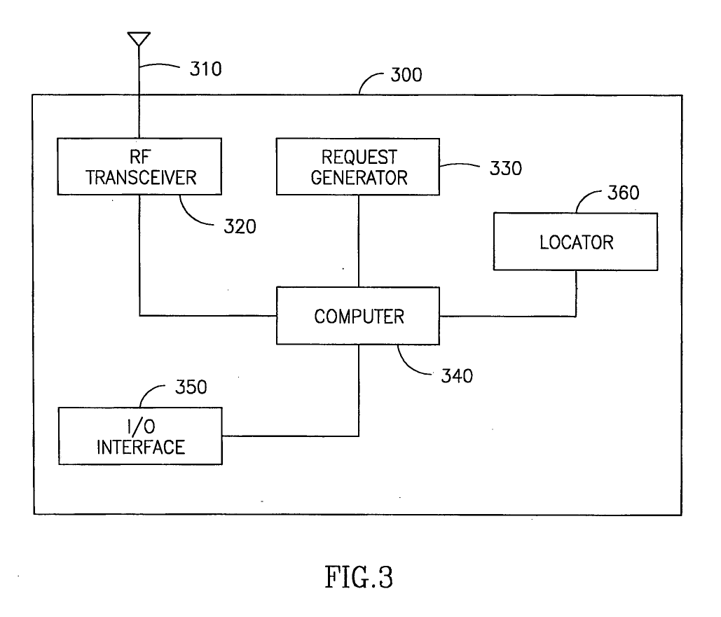

Turning to FIG. 3, a block diagram of a requesting device 300 according to an exemplary embodiment of the invention is shown. Although the scope of the present invention is not limited in this respect, an antenna 310 may be attached to requesting device 300. For example, antenna 310 may be an omni-directional antenna, a dipole antenna and the like. In some embodiments, requesting device 300 may be a wireless mobile station and may include a radio frequency (RF) transceiver 320, a computer 330, a request generator 340, an input/output (I/O) interface 350 and a locator 360.

Although the scope of the present invention is not limited in this respect, RF transceiver may be used to connect the requesting device to a wireless communication system. Request generator 330 may be used to generate a request for sharing capabilities, for example, a request to share a high quality display, a camera, a security application or the like. The request may include location information from locator 260 and the type of a desired I/O connection to the sharing device based on the capabilities of I/O interface 350. Computer 340 may process the information from locator 360, I/O interface 350 and may control the operation of RF transceiver 320 and request generator 330, if desired.

Although the scope of the present invention is not limited in this respect, locator 360 may be a radio triangulation system, for example, a global positioning system (GPS) receiver and/or hotspot proximity detection system, and the like. Locator 360 may transmit the location of the requesting device to server 200 via RF transceiver 320 and antenna 310. Server 200 may receive the request and may locate a sharing device 180 that matches the request.

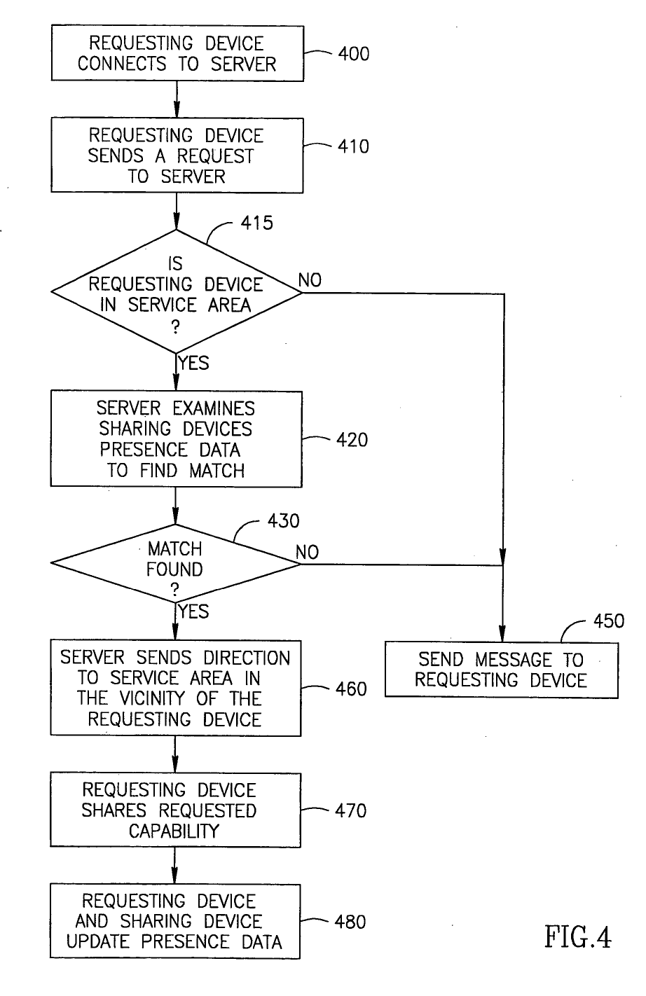

Reference is now made to FIG. 4, which is a flowchart illustrating a method of sharing device capabilities according to some exemplary embodiments of the present invention. Although the scope of the present invention is not limited in this respect, at block 400, requesting device 300 may connect to server 200, for example, via a subscription to a service provider or using any other suitable connection. Requesting device 300 may send a request for capabilities-sharing service to server 200 (block 410).

Although the scope of the present invention is not limited in this respect, an exemplary request as described above may include the type of requesting device, e.g., laptop computer, it's the IP address of the device (for networks supporting Internet Protocol), the device location, and details of the request. A non-limiting example of details of a request may be, for example, a projector.

Although the scope of the present invention is not limited in this respect, server 200 may search if requesting device 300 may be in a service area, e.g., service area 160, of server 200 and/or in the vicinity of the service area (block 415). If requesting device 300 is not in the service area, server 200 may send a message to requesting device 300. The message may include information on reserved sharing devices in other service areas, e.g., not in the vicinity of requesting device 300. Requesting device 300 may confirm or decline this option. If requesting device 300 is in the service area and/or in the vicinity of the service area, server 200 may then examine the sharing-device presence data 250 to check whether there are any suitable sharing devices in the vicinity of requesting device 300 to match its request. If there are no sharing devices 180 of service area 160 in the vicinity of requesting device 300, server 200 may send a notification to requesting device 300 to inform its user that currently there are no sharing devices available (block 450). If there are one or more sharing g devices 180 in the vicinity of requesting device 300, server 200 may perform a query on sharing-device presence data 250 to match an available sharing device that may have the requested sharing capability (block 430).

If no match is found, server 200 may send a notification to requesting device 300 to inform its user that currently there are no sharing devices available (block 450). If there is a match, server 200 may reserve the matched sharing device for use by the requesting device and may send information to provide the user of the requesting device with directions to a services area in the vicinity of requesting device 300, e.g., service area 160, and the details of the sharing device (block 460). In some embodiments of the invention the reservation of a sharing device may expire if the requesting device does not utilize the sharing device within a predetermined time period, if desired.

Although the scope of the present invention is not limited in this respect, upon arrival of the user to the intended service area, requesting device 300 may connect sharing device 180 and may share the requested capabilities (block 470). As indicated at block 480, requesting device 300 and sharing device 180 may send an update message to server 200. Server 200 may update requesting devices presence data 250 with the presence information of the requesting devices 120, 130 and may updated sharing devices presence data 240 with the presence data of sharing devices 180, if desired.

Although the scope of the present invention is not limited in this request, in some embodiment of the invention, server 200 may dynamically update the requesting devices presence data 240 of the requesting device and the sharing-devices presence data 250 of the sharing device. For example, sharing device 180 may become unavailable while requesting device 300 may be in route to the sharing device. Server 200 may update sharing-devices presence data 250 to reflect this unavailability, may find another match to requesting device 300, may notify requesting device 300 of the change, and may update the presence data of both the requesting device and the newly matched sharing device accordingly.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus comprising:
a computer to match a request to share a desired capability by comparing stored data of a requesting device with stored data of a sharing device having the desired capability in the vicinity of the requesting device and to provide the requesting device with directions to locate the sharing device having the desired capability.

2. The apparatus of claim 1, wherein the stored data of the requesting device comprises presence data of the requesting device and wherein the stored data of the sharing device comprises presence data of the sharing device.

3. The apparatus of claim 1, further comprising:
a communication interface to provide a connection to a communication system.

4. The apparatus of claim 1, further comprising:
a database application to enable the computer to match said stored data of the requesting device and the sharing device.

5. An apparatus comprising:
a request generator to provide a request to share a desired capability; and
a locator to provide a location information to a server that is able to provide directions to locate a sharing device having the desired capability in a vicinity of the server.

6. The apparatus of claim 5, further comprising:
an input/output interface to provide connection to the sharing device.

7. The apparatus of claim 6, wherein the input/output interface comprises a wireless tranceiver.

8. The apparatus of claim 6, wherein the input/output interface comprises an infrared transceiver.

9. The apparatus of claim 5, wherein the server is a presence server.

10. The apparatus of claim 5, wherein the locator comprises a radio triangulation system.

11. The apparatus of claim 10 wherein the radio triangulation system comprises a global positioning system.

12. A communication system comprising:
a server to provide capabilities sharing service; and
a mobile station to request and receive capabilities sharing service from the server based on vicinity of the mobile device to a sharing device having a desired capability.

13. The communication system of claim 12 wherein the server comprises:
a computer to match a request to share a desired capability by comparing data of a requesting device in a requesting devices presence data with data of a sharing device having the desired capability in the vicinity of the requesting device in a sharing devices presence data and to provide to the requesting device directions to the sharing device having the desired capability.

14. The communication system of claim 12 wherein the mobile station comprises:
a request generator to provide a request to share a desired capability; and
a locator to provide a location information to a server that is able to provide directions to locate a sharing device having the desired capability in a vicinity of the server.

15. A method comprising:
receiving from a mobile station a request to share a desired capability located in the vicinity of said mobile station; and
matching a sharing device to the request by comparing presence information and said desired capability of said mobile station to stored capabilities and presence information of sharing devices in the vicinity of the mobile station to find a matching sharing device.

16. The method of claim 15 further comprising:
sending to said mobile station a notification identifying the location of said matching sharing device.

17. The method of claim 15 further comprising:
sending a notification to said mobile station that no match was found.

18. The method of claim 15 further comprising:
enabling a connection between said mobile station and said matching sharing device.

19. The method of claim 15 further comprising:
updating the presence information of said mobile station and of said matching sharing device.

20. The method of claim 15, wherein receiving said request comprises receiving an identification of said mobile station.

21. The method of claim 15, wherein receiving said request comprises receiving an updated location of said mobile station.

22. An apparatus comprising:
a request generator to provide a request to share a desired capability; and
a locator to provide a location information to a server that is able to provide directions to locate a sharing device having the desired capability in a vicinity of the server; and
an omni-directional antenna to transmit the request to the server.

23. The apparatus of claim 22, further comprising:
an input/output interface to provide connection to the sharing device.

24. The apparatus of claim 23, wherein the input/output interface comprises a wirless transciver.

25. The apparatus of claim 22, wherein the locator comprises a global positioning system (GPS) receiver.

26. An article comprising a storage medium having stored thereon instructions that, when executed by a processing platform, result in:
receiving from a mobile station a request to share a desired capability located in the vicinity of said mobile station; and
matching a sharing device to the request by comparing presence information and said desired capability of said mobile station to stored capabilities and presence information of sharing devices in the vicinity of the mobile station to find a matching sharing device.

27. The article of claim 26, wherein the instructions when executed further result in:
sending to said mobile station a notification identifying the location of said matching sharing device.

28. The article of claim 26, wherein the instructions when executed further result in:
updating said presence information of said mobile station and said presence information of said matching sharing device.
